(19) United States
(12) Patent Application Publication
(10) Pub. No.: US 2009/0043770 A1
(43) Pub. Date: Feb. 12, 2009

(54) Method of Realizing Commands Synchronization in Supporting Multi-Threading Non-Volitale Memory File System

(76) Inventor: Hongyu Wang, Shanghai (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 10/580,618

(22) PCT Filed: Oct. 24, 2005
(86) PCT No.: PCT/CN05/01754

§ 371 Date: May 24, 2006

(51) Int. Cl. G06F 7/00; G06F 17/30

(52) U.S. Cl. 707/8; 707/E17.007; 707/E17.01

(57) ABSTRACT

A method may be used in a multi-threading non-volatile memory file system. The method comprises creating a data structure to store progress information on one or more concurrent operations to access a file system of a non-volatile memory; and executing the one or more concurrent operations based on the progress info.

### BACKGROUND

A file system of a non-volatile memory may be organized as a directory-file structure, such as a tree-shaped structure. A root of the tree may be a root directory. Going through the tree, the root directory may be associated with one or more directories and then the directories may be associated with one or more files. Each directory or file may have one or more sectors that may be dynamically allocated in the non-volatile memory at different locations. The sectors may be linked by a data structure, such as a sequence table. If there are multiple concurrent read/write commands on the same file or directory, a lower priority read/write may be pre-empted by a higher priority write. The higher priority write may move the sequence table to a new physical location (like replacement), after the higher priority write completes. However, the lower priority read/write command may not know the new location of the sequence table. A similar situation occurs for multiple writes on different files that may cause the parent directory location change.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a file system of a non-volatile memory.

FIG. 2 illustrates an embodiment of an information fragment in a file system of a non-volatile memory.

FIG. 3 illustrates an embodiment of a sequence table, in a file system of a non-volatile memory.

FIG. 4 illustrates an embodiment of a data structure, such as a track table and corresponding lists attached to the track table.

FIG. 5 illustrates an embodiment of a system of the present invention.

FIG. 6 is a flowchart illustrating an embodiment of a method that may be used to read a file or a directory of a non-volatile memory.

FIG. 7 is a flowchart illustrating an embodiment of a method that may be used to write a file or a directory of a non-volatile memory.

### DETAILED DESCRIPTION

The following description describes techniques for realizing commands synchronization in supporting a non-volatile memory file system, for example multi-threading flash file system. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. However, the invention may be practiced without such specific details.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

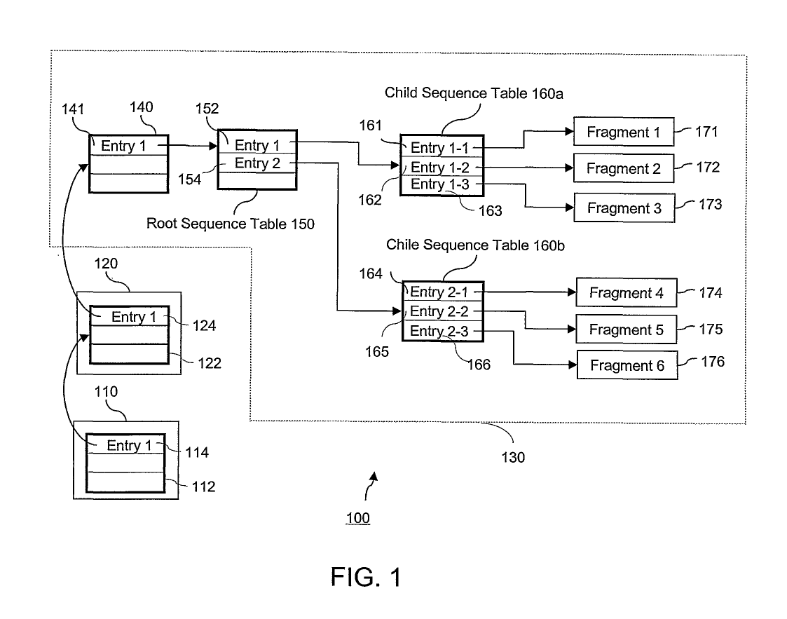

Referring now to FIG. 1, a file system 100 of a non-volatile memory may comprise, for example, a tree-shaped directory-file structure. In one embodiment, file system 100 may comprise a root directory 110. Root directory 110 may comprise a root directory information fragment 112. In another embodiment, file system 100 may further comprise a directory 120; however, other embodiments may comprise a different number of directories. In another embodiment, file system 100 may comprise more levels of directories. Directory 120 may comprise a directory information fragment 122. In one embodiment, root directory information fragment 112 may comprise one or more entries that may each be associated with a directory information fragment. For example, entry 114 may comprise a pointer that may point to directory information fragment 122. In one embodiment, the pointer may point to a first sector of directory information fragment 122.

In one embodiment, file system 100 may further comprise a file 130; however, other embodiments may comprise a different number of files. For example, file 130 may comprise a file information fragment 140. Directory information fragment 122 may comprise an entry 124 that may be associated with file information fragment 140; however, other embodiments may comprise a different number of entries. For example, entry 124 may include a pointer that may point to the file information fragment 140, e.g., a first sector of file information fragment 140. In one embodiment, file 130 may further comprise zero or more sequence table, for example, a sequence table may be implemented using various data structures, such as lists, arrays, etc. In one embodiment, file 130 may comprise a root sequence table with zero or more child sequence tables, to accommodate different number of file data fragments. For example, FIG. 1 shows that file 130 comprise a root sequence table 150 with two child sequence tables 160a and 160b. In one embodiment, a sequence table may comprise one or more sectors.

Referring to FIG. 1, in one embodiment, file information fragment 140 may comprise an entry 141 that may be associated with root sequence table 150. For example, entry 141 may comprise a pointer that may indicate the location of root sequence table 150, e.g., a first sector of root sequence table 150. In another embodiment, file information fragment 140 may comprise one or more entries (for example, pointers) that may each point directly to a corresponding file data fragment, for example, file data fragments 171-176, if there is no need for a sequence table since the number of entries in file information fragment 140 is not less than that of the file data fragments in file 130.

In another embodiment, root sequenced table 150 may comprise one or more entries that may each be associated with a child sequence table. For example, root sequence table 150 may comprise entries 151 and 152 that may be associated with child sequence tables 160a and 160b, respectively. In another embodiment, root sequence table 150 may comprise one or more entries that may each be associated with a corresponding file data fragment, if there is no need for a child sequence table since the number of entries in root sequence table 150 is not less than that of the file data fragments in file 130. In yet another embodiment, each of entries 151 and 152 may include a pointer that may indicate the locations of child sequence tables 160a and 160b, respectively. For example, a pointer may point to a first sector of a child sequence table.

With reference to FIG. 1, file 130 may comprise one or more file data fragments, for example, file data fragments 171-176. In one embodiment, child sequence tables 160a and 160b may comprise entries that may each be associated with file data fragments 171-176, respectively. For example, child sequence tables 160a and 160b may comprise pointers that may each indicate a location of a corresponding one of file data fragments 171-176. Although FIG. 1 shows that file 130 may comprise a root sequence table and two child sequence table, in other embodiments, file system 100 may comprise a root sequence table and one or more child sequence table for a root directory or a directory to accommodate more directories and files, respectively. In another embodiment, file system 100 may comprise multi levels of child sequence tables.

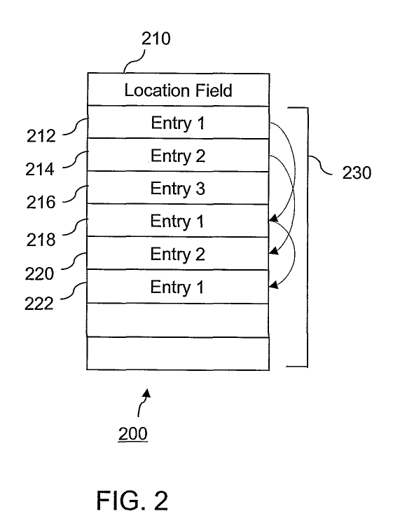

Referring now to FIG. 2, an embodiment of an information fragment 200 is shown. For example, information fragment 200 may include root directory information fragment, directory information fragment or file information fragment. In one embodiment, information fragment 200 may comprise one or more sectors that may be continuous. In another embodiment, information fragment 200 may comprise a data structure of one or more entries 230 that may each indicate a location of a corresponding fragment that links to information fragment 200. For example, each of entries 212, 214 and 216 may comprise a pointer that may point to a fragment or a root sequence table (e.g., a first sector thereof) attached to information fragment 200; however, in other embodiments, information fragment 200 may comprise a different number of entries. For example, root directory information fragment 112 of FIG. 1 may comprise entry 114 (for example a pointer) that may be associated with directory information fragment 122. In another embodiment, information fragment 200 may comprise one or more blank entries reserved for future entries. For example, blank entries may follow existing entries. In yet another embodiment, information fragment 200 may comprise one or more entries that may have the same index or serial number. For example, entries 212, 218 and 222 may have the same serial number, such as “1”. The last entry 222 of the three may be considered as a valid latest entry and entries 212 and 218 may be considered as invalid. Similarly, entries 214 and 220 may have the same serial number “2”. The last entry 220 may be considered as a valid latest entry and entry 214 may be considered as invalid.

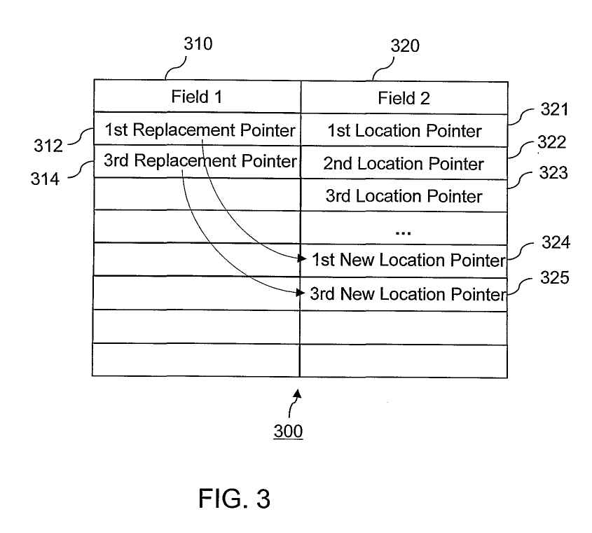

Referring to FIG. 3, an embodiment of a sequence table 300 is shown. For example, sequence table 300 may include root sequence table or child sequence table. In one embodiment, sequence table 300 may comprise one or more sectors that may be continuous. In another embodiment, sequence table 300 may comprise a data structure, such as lists, arrays, etc. For example, sequence table may comprise a first field 310 and a second field 320 to indicate linkage among fragments. For example, referring to FIG. 1, file data fragments 171-176 may link to file information fragment 140 via root sequence table 150 and child sequence tables 160a and 160b, wherein root sequence table 150 is a parent sequence table.

In one embodiment, the first field 310 may comprise a replacement pointer field and the second field 320 may comprise a location pointer field. In another embodiment, the second field 320 may indicate a location of a fragment or a child sequence table that may attach to sequence table 300. The first field 310 may represent a location of a new entry that updates an existing entry of the second field 320. For example, entry 321 of the second field 320 may comprise a location pointer 1 that is associated with an existing fragment. If the existing fragment is replaced by a new fragment or moved to a new location, entry 312 of the first field 310 may comprise a first replacement pointer that may point to entry 324, which may comprise a first new location pointer to the new fragment or new location to replace the first location pointer of entry 321. Moreover, entries 322 and 323 of the second field 320 may comprise a second and a third location pointers, respectively, that may each point to a fragment. Entry 314 of the first field 310 may comprise a third replacement pointer that may point to entry 325, which may comprise a third new location pointer to replace the third location pointer of entry 323.

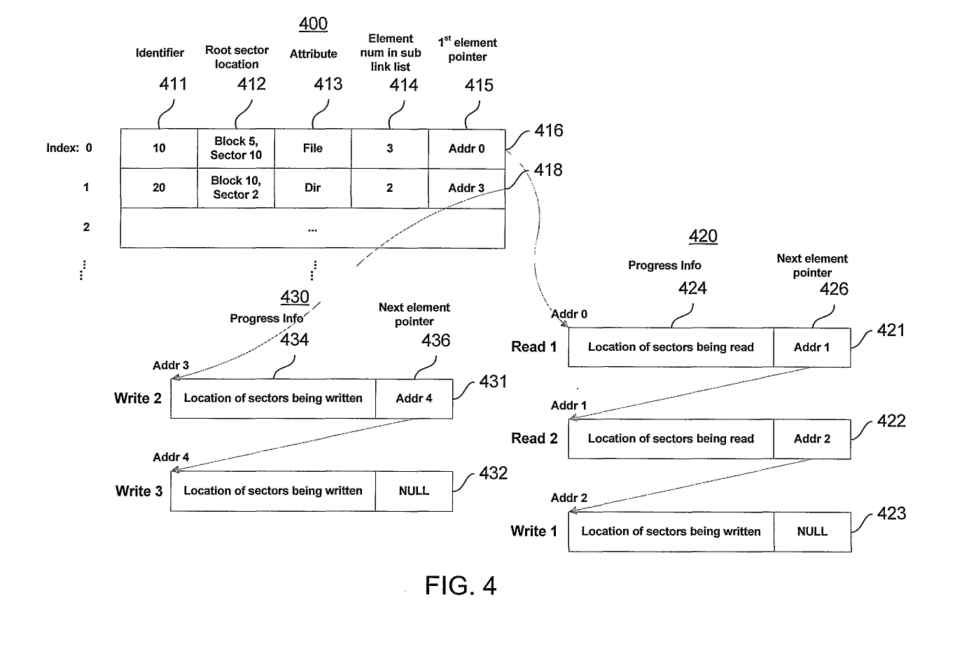

Now referring to FIG. 4, an embodiment of a data structure 400 is shown. Data structure 400 may store information or primary information on one or more files and/or one or more directories being operated concurrently. Data structure 400 may be implemented in various forms, such as lists, arrays, etc. In one embodiment, the information may be used to identify the one or more files or directories. Referring to FIG. 4, a first element 416 may relate to a file and a second element 418 may relate to a directory. In one embodiment, data structure 400 may comprise a track table. In another embodiment, data structure 400 may comprise one or more fields, such as fields 411-415. For example, for each element, a first field 411 may comprise an identifier that may identify a file or directory that is operated by one of the concurrent operations; a second field 412 may indicate a location associated with the file or directory, for example, a location of a root sector or a first sector of the file or directory; a third field 413 may comprise an attribute that may indicate a type of the file or the directory; a fourth field 414 may indicate a number of elements in a list (for example, 420 or 430) associated with the file or the directory, such as a number of concurrent operations on the file or the directory; and a fifth field 415 may comprise a link to the list, such as an address or a pointer to a first element in the list. However, other embodiments may comprise different fields to accommodate different primary information. In another embodiment, data structure 400 may be dynamically allocated in a volatile memory. The number of elements in data structure 400 may depend on how many files or directories being operated, such as read or written, simultaneously.

FIG. 4 further shows an embodiment of a first list 420 and a second list 430 that may correspond to the first element 416 and the second element 418, respectively. In one embodiment, the first and second lists 420 or 430 may comprise various types of data structures, such as signal linked lists, double linked lists, arrays, vectors, etc. The first list 420 may comprise one or more elements to track progress of all concurrent operations on the same file that is indicated by element 416. In one embodiment, the first list 420 may comprise elements 421-423 that may be associated with operations, READ 1, READ 2 and WRITE 1, respectively; however, other embodiments may comprise a different number of elements to accommodate a different number of operations and may apply to different operations. In another embodiment, the first list 420 may be dynamically stored in a volatile memory and elements 421-423 may be dynamically allocated at different addresses of the volatile memory.

Referring to FIG. 4, in one embodiment, each element of the first list 420 may comprise a progress information or data field 424 that may comprise progress information or progress data about one of the concurrent operations, for example, locations or pointers of sectors being operated in the operation. For example, said sectors may belong to one or more information fragments or sequence tables. In another embodiment, said sectors may comprise a first sector of one or more information fragments or sequence tables. Each element of the first list 420 may further comprise link information or data field or a next element location field 426 that may link one or more elements, for example 421-423, relating to the same file or directory. For example, the next element location field 426 may comprise an address or a pointer to a next element in the first list 420. For example, the next element pointer field 426 may indicate an address of a volatile memory where an element on a next operation is stored. For example, the first element 421 of the first list 420 may comprise locations of sectors being read in READ 1 and an address 1 associated with the next operation READ 2. In another embodiment, the last element 423 may comprise locations of sectors being written in WRITE 1 with a null next element location field, because there is not any next operation in the first list 420. Similarly, the second list 430 associated with a directory that is indicated by element 418 may comprise information of operations on the directory. The description on the second list 430 may refer to that of list 420, and thus is omitted herein. Although the first and second lists 420 and 430 are illustrated as separated from data structure 400, in other embodiments, elements of each list may be included in data structure 400.

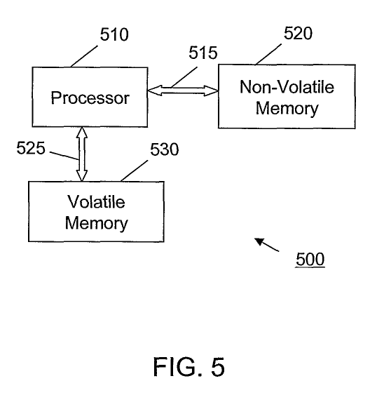

Now Referring to FIG. 5, a diagram of a system level overview according to one embodiment of the present invention is illustrated. As shown in FIG. 5, the system 500 includes a processor 510, a non-volatile memory 520 and a volatile memory 530. Processor 510 may be any type of processor adapted to perform operations in non-volatile memory 520 or volatile memory 530. For example, processor 510 may be a microprocessor, a digital signal processor, a microcontroller, or the like.

Non-volatile memory 520 may comprise non-volatile memory, or the like. Processor 510 and non-volatile memory 520 may be coupled by bus 515. Volatile memory 530 may comprise RAM, or the like. Processor 510 and volatile memory 530 may be coupled by bus 525. In one embodiment, processor 510, non-volatile memory device 520 and the volatile memory 530 may be included on an integrated circuit board, and buses 515 and 525 may be implemented using traces on the circuit board. In another embodiment, processor 510, non-volatile memory 520 and the volatile memory 530 may be included within the same integrated circuit, and buses 515 and 525 may be implemented using interconnect within the integrated circuit.

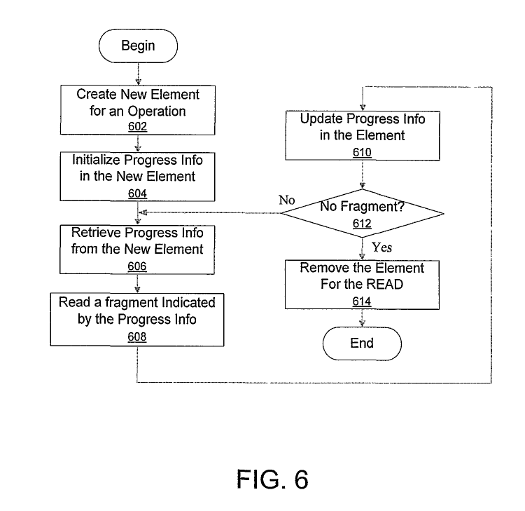

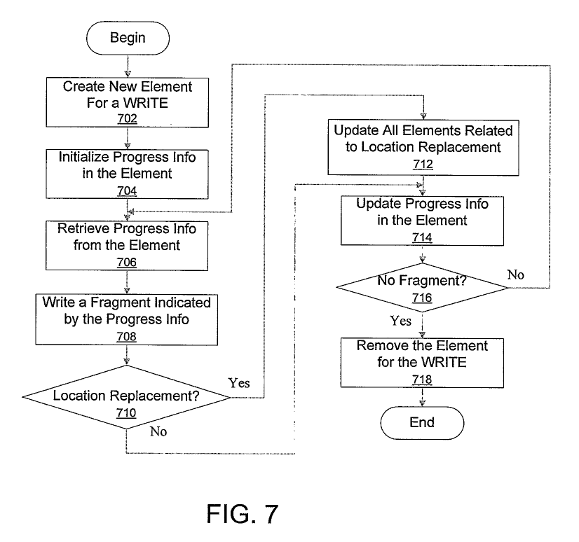

Processor 510 may perform operations in non-volatile memory 520 or volatile memory 530. In one embodiment, processor 510 may perform operations in the method as shown in FIGS. 6 and 7, which will be described in the following paragraphs. In one embodiment, processor 510 may be not dedicated to the use of non-volatile memory 520, and processor 510 may perform operations in non-volatile memory 520 or volatile memory 530 while also performing other system functions.

An example method is illustrated in FIG. 6 that may be used by processor 510 to read a file or a directory from non-volatile memory 520. In one embodiment, processor 510 may establish in volatile memory 530 a data structure, such as 400, that may comprise one or more elements, wherein each element may record primary information on a file or a directory being operated. In another embodiment, processor 510 may build up in the volatile memory one or more lists, such as 420 and 430, that may be attached to each element of the data structure 400 and may comprise progress information on all concurrent operations on the file or the directory identified by each element. In yet another embodiment, instead of using one or more lists, processor 510 may combine elements in lists 420 and 430 in data structure 400 for all concurrent operations. The following description on the method of FIG. 6 may make reference to the embodiment of FIG. 4; however, other embodiments may adopt different data structures to track information on each concurrent operation.

In block 602, processor 510 may create a new element for a READ operation, for example, READ 1. Referring to the embodiment of FIG. 4, processor 510 may create in data structure 400 a new element 416 that may comprise information on a file, for example file A, being operated in READ 1, in response to determining that data structure 400 does not comprise an element regarding file A. In another embodiment, processor 510 may create in the first list 420 a new element 421 for READ 1 that may read one or more sectors of file A. Element 421 may be attached to element 416 of data structure 400. In yet another embodiment, processor 510 may combine elements 416 and 421 in the same data structure 400. In block 604, processor 510 may initialize the progress information in element 421. In one embodiment, processor 510 may store locations of sectors of file A being read in READ 1. In another embodiment, processor 510 may add the address of element 421 into a preceding element (not shown) of the first list 420.

In block 606, processor 510 may retrieve the progress information regarding a fragment, for example fragment X, of file A in element 421. In one embodiment, processor 510 may obtain one or more locations corresponding to one or more sectors belonging to fragment X. Processor 510 may read fragment X according to the locations as obtained in block 606 (block 608). In one embodiment, processor 510 may find the locations as obtained in block 606 and read fragment X therefrom. In block 610, processor 510 may update the progress information or data in element 421 in response to determining that the reading of fragment X is completed. In one embodiment, processor 510 may delete from element 421 the locations associated with fragment X. In block 612, processor 510 may determine whether there is any other fragment being read in READ 1. In one embodiment, processor 510 may determine all the fragment(s) of file A have been read, in response to determining that element 421 does not comprise a location of any sector being read, and processor 510 may remove element 421 for READ 1 from the first list 420 (block 614). In another embodiment, processor 510 may further update data structure 400 by removing element 416 if there is no more operation regarding file A. Conversely, processor 510 may continue to blocks 606, 608, 610 and 612, in response to determining that there are one or more fragments being read in READ 1. In one embodiment, processor 510 may determine whether there are one or more fragments being read in READ 1 based on the progress information or data of element 421. Although the method of FIG. 6 is described with particular reference to FIG. 4, other embodiments may apply to a different operation on a different file or directory.

An example method is illustrated in FIG. 7 that may be used by processor 510 to write a file or a directory in non-volatile memory 520. In one embodiment, processor 510 may establish in volatile memory 530 a data structure, such as 400, that may comprise one or more elements, wherein each element may record primary information on a file or a directory being operated. In another embodiment, processor 510 may build up in the volatile memory one or more lists, such as 420 and 430, that may be attached to each element of the data structure 400 and may comprise progress information on all concurrent operations on the file or the directory identified by each element. In yet another embodiment, instead of using one or more lists, processor 510 may combine elements in lists 420 and 430 in data structure 400 for all concurrent operations. The following description on the method of FIG. 6 may make reference to the embodiment of FIG. 4; however, other embodiments may adopt different data structures to track information on each concurrent operation.

In block 702, processor 510 may create a new element for a WRITE operation, for example, WRITE 1. Referring to the embodiment of FIG. 4, processor 510 may create in data structure 400 a new element 416 that may comprise information on a file, for example file A, being operated in WRITE 1, in response to determining that data structure 400 does not comprise an element regarding file A. In another embodiment, processor 510 may create in the first list 420 a new element 423 for WRITE 1 that may write one or more sectors of file A. Element 423 may be attached to element 416 of data structure 400. In yet another embodiment, processor 510 may combine elements 416 and 423 in the same data structure 400. In block 704, processor 510 may initialize the progress information in element 423. In one embodiment, processor 510 may store locations of sectors of file A being written in WRITE 1. In another embodiment, processor 510 may add the address of element 423 into a preceding element (not shown) of the first list 420.

In block 706, processor 510 may retrieve the progress information regarding a fragment, for example fragment X, of file A in element 423. In one embodiment, processor 510 may obtain one or more locations corresponding to one or more sectors belonging to fragment X. Processor 510 may write fragment X according to the locations as obtained in block 706 (block 708). In block 710, processor 510 may determine whether any sector or non-fragment unit or fragment replacement occurs during writing fragment X. For example, in response to determining that one or more sequence table associated with fragment X and/or fragment X are moved to one or more new physical locations (such as sector locations or non-fragment unit locations), processor 510 may update all elements of file A in the first list 420 relating to the location replacement with the one or more new locations (block 712). In one embodiment, processor 510 may replace one or more original sector locations in the first list 420 by corresponding new locations according the location moving. In block 714, processor 510 may update the progress information or data in element 423 in response to determining that the writing of fragment X is completed. In one embodiment, processor 510 may delete from element 423 the locations associated with fragment X.

In block 716, processor 510 may determine whether there is any other fragment being written in WRITE 1. In one embodiment, processor 510 may determine all the fragment(s) of file A have been written, in response to determining that element 423 does not comprise a location of any sector being written, and processor 510 may remove element 423 for WRITE 1 from the first list 420 (block 718). In another embodiment, processor 510 may further update data structure 400 by removing element 416 if there is no more operation regarding file A. Conversely, processor 510 may continue to blocks 706, 708, 710, 712, 714 and 716, in response to determining that there are one or more fragments being written in WRITE 1. In one embodiment, processor 510 may determine whether there are one or more fragments being written in WRITE 1 based on the progress information/data of element 423. Although the method of FIG. 7 is described with particular reference to FIG. 4, other embodiments may apply to a different operation on a different file or directory.

While the methods of FIGS. 6 and 7 are illustrated as a sequence of operations, processor 510 in some embodiments may perform illustrated operations of the method in a different order. In one embodiment, processor 510 may perform one or more concurrent operations simultaneously according to FIG. 6 and/or FIG. 7. In another embodiment, according to data structure 400, processor 510 may detect whether there is a high priority operation on a file or directory in all concurrent operations on the same file or directory before performing any of the concurrent operations. If processor 510 detects that there is such a high priority operation, processor 510 may perform the high priority operation according to FIGS. 6 or 7 first. Processor 510 may perform other concurrent operations after the completion of the high priority operation. In another embodiment, processor 510 may perform such detection during performing one of the concurrent operations. In response to detecting such a high priority operation, processor 510 may perform the high priority operation after completing the one concurrent operation on a fragment of the file or directory and processor 510 may continue the one concurrent operation on remaining fragment(s) of the file or directory upon the completion of the high priority operation.

In one embodiment, processor 510 may generate a new element in data structure 400 for each concurrent operation before performing any of the concurrent operations. For example, blocks 602 and 702 may be omitted from FIGS. 6 and 7, respectively. For example, a new element may comprise information on a file or directory to be operated by a concurrent operation and progress information/data about the concurrent operation. In addition, data structure 400 may also comprise link information/data to link elements relating to the same file or directory. In another embodiment, processor 510 may add one or more elements that may each identify a file or directory being operated by the concurrent operations. In another embodiment, processor 510 may record progress information/data for each of the concurrent operations in a corresponding element of the data structure 400. In yet another embodiment, processor 510 may record progress information/data for each operation as lists, etc. In one embodiment, processor 510 may perform initialize the progress information/data before executing any of the concurrent operations. For example, blocks 604 and 704 may be omitted from FIGS. 6 and 7, respectively.

While certain features of the invention have been described with reference to embodiments, the description is not intended to be construed in a limiting sense. Various modifications of the embodiments, as well as other embodiments of the invention, which are apparent to persons skilled in the art to which the invention pertains are deemed to lie within the spirit and scope of the invention.

What is claimed is:

1. A method comprising creating a data structure to store progress information on one or more concurrent operations to access a file system of a non-volatile memory; and
executing the one or more concurrent operations based on the progress info.

2. The method of claim 1 further comprising
initializing the progress information to include one or more locations of a non-fragment unit of the file system being operated in each concurrent operations.

3. The method of claim 1 further comprising
retrieving the progress information to obtain one or more locations of a non-fragment unit of the file system associated with each concurrent operation.

4. The method of claim 1 further comprising
operating on a fragment of the file system as indicated by the progress information according to each concurrent operation.

5. The method of claim 1 further comprising
updating the progress information associated with a concurrent operation, in response to the completion of the concurrent operation on a fragment of the file system.

6. The method of claim 5 further comprising
from the progress information associated with the concurrent operation, deleting one or more locations of a non-fragment unit of the file system associated with the fragment.

7. The method of claim 1, further comprising
continuing each concurrent operation on one or more fragments of the file system, in response to determining that the progress information associated with the concurrent operation comprises one or more locations of a non-fragment unit of the file system associated with the one or more fragments.

8. The method of claim 1 further comprising
removing the progress information for each concurrent operation, in response to determining that the concurrent operation on the file system is completed.

9. The method of claim 1 further comprising
in response to determining that one concurrent operation moves one or more locations of a non-fragment unit of the file system to one or more new locations, updating the progress information relating to the one or more locations with the one or more new locations.

10. The method of claim 1, further comprising
in response to determining that a write operation replaces one or more sequence tables of the file system by one or more new sequence tables, updating the progress information on the one or more sequence tables with progress information on the one or more new sequence tables.

11. The method of claim 1, further comprising
detecting whether there are one or more high priority operations in the one or more concurrent operations, during executing each concurrent operation on a fragment of the file system as identified by the progress info.

12. The method of claim 11, further comprising
in response to detecting one or more high priority operations, performing the one or more high priority operations after completing the concurrent operations on the fragment.

13. A system comprising
a non-volatile memory,
a volatile memory, and
a processor to store in the volatile memory a data structure that comprises location data associated with one or more concurrent operations to access a file system of the non-volatile memory, and to perform the one or more concurrent operations according to the location data.

14. The system of claim 13, wherein the processor further to initialize the location data to include location data of one or more sectors in the file system, wherein the one or more sectors are operated by the concurrent operations.

15. The system of claim 13, wherein the processor further to obtain addresses of one or more sectors being operated by each concurrent operation from the location data.

16. The system of claim 13, wherein the processor further to perform each concurrent operation on a fragment of the file system as indicated by the location data.

17. The system of claim 13, wherein the processor further to delete the location data associated with a concurrent operation on a fragment of the file system, in response to determining that the concurrent operation on the fragment is completed.

18. The system of claim 17, wherein the processor further to continue the concurrent operation on one or more fragments of the file system, in response to determining that the data structure comprises location data associated with the concurrent operation on the one or more fragments after the deleting.

19. The system of claim 13, wherein the processor further to removing the location data on a concurrent operation from the data structure, in response to determining that the concurrent operation is completed.

20. The system of claim 13, wherein in response that a concurrent operation on a fragment of the file system replaces existing location data on one or more sectors of the file system, the processor further to update location data associated with one or more other concurrent operations on the same one or more sectors according to the replacement.

21. The system of claim 20, wherein in response to determining that the concurrent operation replaces the existing location data by new location data, the processor further to update the location data associated with the one or more other concurrent operations with the new location data.

22. The system of claim 13, wherein in response that a write operation on a fragment of the file system replaces one or more exiting sector locations of the file system by one or more new sector locations, the processor further to update the same one or more existing sector locations in location data on one or more other concurrent operations with the one or more new sector locations.

23. The system of claim 13, wherein in response to determining that one or more high priority operations are detected during a concurrent operation, the processor further to perform the one or more high priority operations after completing the concurrent operation on a fragment of the file system as identified by the location data.

24. A machine readable medium comprising a plurality of instructions that in response to being executed result in a computing device
storing a track table, wherein each entry of the track table comprises one or more sector locations of a file system of a non-volatile memory being operated by one or more concurrent operations, and
performing the one or more concurrent operations on the one or more sector locations.

25. The machine readable medium of claim 24 further comprising a plurality of instructions that in response to being executed result in a computing device
initializing the track table to further include information to identify at least one of files and directories in the file system being operated by one or more of the concurrent operations.

26. The machine readable medium of claim 24 further comprising a plurality of instructions that in response to being executed result in a computing device
performing each concurrent operation on a corresponding fragment of the file system as indicated by one or more sector locations associated with the concurrent operation.

27. The machine readable medium of claim 24 further comprising a plurality of instructions that in response to being executed result in a computing device
deleting from the track table one or more sector locations associated with a concurrent operation on a fragment of the file system, in response to determining that the concurrent operation on the fragment is completed.

28. The machine readable medium of claim 27 further comprising a plurality of instructions that in response to being executed result in a computing device
in response to determining that the track table comprises one or more sector locations associated with the concurrent operation after the deleting, continuing the concurrent operation on a fragment identified by the one or more sector locations.

29. The machine readable medium of claim 24 further comprising a plurality of instructions that in response to being executed result in a computing device
removing from the track table an entry associated with a concurrent operation in response to determining that the concurrent operation is completed.

30. The machine readable medium of claim 24 further comprising a plurality of instructions that in response to being executed result in a computing device
in response to determining that a concurrent operation moves a sector location to a new sector location, updating one or more entries of the track table that relate to the sector location with the new sector location.

31. The machine readable medium of claim 24 further comprising a plurality of instructions that in response to being executed result in a computing device
in response to determining that a concurrent operation on a fragment replaces a sequence table by a new sequence table, updating one or more entries of the track table that comprise sector locations of the one or more sequence tables with sector locations of the one or more new sequence tables.
